(19) United States
(12) Patent Application Publication
(10) Pub. No.: US 2022/0120044 A1
(43) Pub. Date: Apr. 21, 2022

(54) ROADWAY MARKING SYSTEM AND METHOD

(71) Applicant: DeLeo Delineation Concepts LLC, Johnston, RI (US)

(72) Inventor: James DeLeo, Johnston, RI (US)

(21) Appl. No.: 17/502,072

(22) Filed: Oct. 15, 2021

Related U.S. Application Data
(60) Provisional application No. 63/092,936, filed on Oct. 16, 2020.

(51) Int. Cl. E01F 9/553; E01F 9/512; G02B 5/128

(52) U.S. Cl. CPC E01F 9/553; G02B 5/128; E01F 9/512

(57) ABSTRACT

The present invention is a roadway marking having a recessed longitudinal groove provided in the roadway parallel to the direction of traffic. The groove has an inclined bottom surface that gradually tapers upward in the direction of traffic on the roadway. At least one retroreflective element is provided in the groove. The retroreflective element can be a reflector, a preformed reflective member, or a layer of retroreflective beads provided on a water-based or thermoplastic binder.

### BACKGROUND OF THE INVENTION

### Field of the Invention

The present invention relates to the field of roadway markings and more particularly to roadway markings affixed within a groove in a roadway surface.

### Background of the Related Art

Retroreflective elements are incorporated in traffic signs, pavement markings and apparel. Pavement markings, for example such as those on the centerline and edge of a roadway, provide visual guidance for motor vehicle drivers. The visibility provided by these pavement markings is particularly vital for night time navigation and for navigation during inclement weather conditions.

Pavement markings can be applied directly to the road surface by applying a binder followed by a retroreflective element such as a retroreflective glass bead and/or a drying or curing agent for the binder. When applied directly to the road surface, these roadway markings are subject to wear from traffic and abrasion from snow plows and other road clearing machinery. This wear will remove the retroreflective elements thereby reducing the visibility of the pavement markings in nighttime and inclement weather conditions.

Alternatively, reflective elements such as raised pavement markers can be applied to the roadway surface. The most common traditional pavement markers used are set in a metal casting, usually cast iron, and are raised above the surface of the pavement ¼″ to ½″. General wear from weather and debris on the pavement can deteriorate the foundation between the pavement and marker, which increases the risk of the marker dislodging. The average weight of these markers is approximately 15 pounds, which causes them to act as a hazardous projectile if dislodged by a vehicle.

Alternatively, low profile metal casting pavement markers can be used which are only raised ¼″ or less from the surrounding pavement. The lower profile and increased tapering is intended to provide less of a risk of the pavement markers becoming dislodged. However, the low profile raised pavement markers are susceptible to accidental removal by snow removal equipment.

In addition, lightweight low profile castings made with polycarbonate or acrylonitrile butadiene styrene lightweight frames rather than cast iron have also been used. Although easier to install, the service life for lightweight pavement markers is much lower than those with cast iron castings, especially on roadways that have documented high volumes, high speeds or those that experience frequent plowing.

Recessed pavement markers are an alternative to raised pavement markers. Recessed markers are placed inside of a milled-out groove in order to function at an elevation below or at the surface of the pavement. These markers can come in the form of a preformed strip, which is simply peeled and laid in the groove, or as a marker in a casting. Recessed markers are less likely to become dislodged by snowplows and street sweepers because they don't extend above the surface of the pavement. However, the groove in which the recessed markers are applied naturally collects water and debris, which can decrease the effectiveness of the reflectors and cause the marker to dislodge because the marker sits in water during rainy periods and freezes during the winter months. These markers also are a hazard to motorcyclists when the front wheel hits the groove and hits a blunt surface when exiting. Moreover, the effectiveness of recessed markers is often not as significant as raised pavement markers, since they sit below the surface of the pavement and tend not to reflect as much light back to vehicles.

The present invention is directed toward overcoming one or more of the above-identified problems.

### BRIEF SUMMARY OF THE INVENTION

Increased wet night reflectivity of road markings can be obtained by providing a retroreflective element in a sloping groove milled into the roadway. By providing the retroreflective element on the upper portion of the sloped grove, water and dirt will not pool and settle on the marking. The sloped surface also minimizes the impact of a tire on the edge of the groove, providing increased safety for vehicles, especially motorcycles.

A recessed longitudinal groove is provided in a roadway parallel to the direction of traffic. The groove has an inclined bottom surface that gradually tapers upward in the direction of traffic on the roadway. A retroreflective element is provided in the distal upper portion of the groove. Suitable retroreflective elements include reflectors, preformed reflective members, and a layer of retroreflective beads provided on a binder applied of the bottom surface of the groove.

Further features, aspects, objects, advantages, and possible applications of the present invention will become apparent from a study of the exemplary embodiments and examples described below, in combination with the Figures, and the appended claims.

### BRIEF DESCRIPTION OF THE FIGURES

The above and other objects, aspects, features, advantages and possible applications of the present invention will be more apparent from the following more particular description thereof, presented in conjunction with the following drawings, in which:

FIG. 1 is a schematic view of a roadway showing placement of the grooves of the present invention.

FIG. 2 is a schematic view of a representative groove of the present invention.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

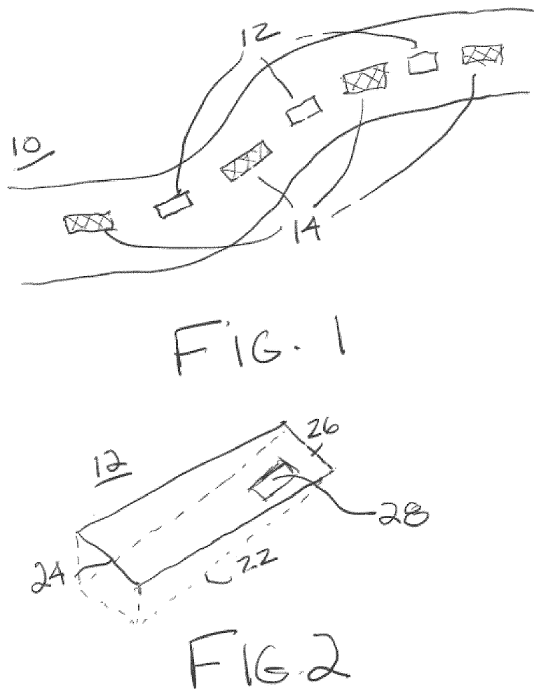

As shown in FIG. 1, grooves 12 are installed in the roadway 10 parallel to the flow of traffic. The grooves 12 are preferably wide enough to accommodate standard roadway markings. In a presently preferred embodiment, the grooves 12 are approximately 3 feet in length and separated from each other by approximately 80 feet. Preferably, these grooves 12 are provided intermediate existing surface line markings 14 on the roadway 10.

As shown in FIG. 2, each groove 12 has a sloping bottom surface 22 which rises to the roadway surface 10 in the direction of travel. The groove 12 preferably has a maximum depth of between ¾ inches and 1 inch at the proximal end 24 and gradually slopes upward to the roadway surface at its distal end 26. Preferably, the groove 12 is approximately 7 inches wide and has vertical sidewalls.

The grinding equipment used to form the grooves shall consist of a free-flow cutting or grinding head designed to provide the desired upward sloping groove depth over all pavement surfaces. The grinder or cutter head shall be equipped with two or more diamond saw blades for the surface and edge of the groove. Preferably, a double diamond grinder or cutter is used that produces a smooth groove pavement surface free of ridges and having near vertically perpendicular clean-cut side interfaces.

The cutting tips should be arranged on the cutting head in such a pattern as to provide a smooth cut. Each cutting head is preferably on its own independent suspension from that of the power unit to allow the tool to self-align with the slope of the shoulder and/or any irregularities in the shoulder surface.

The groove shall have finished dimensions of 7 inches (+/−½ inch) wide in the direction of travel spaced at 80 feet apart, and shall be 36 inches long measured perpendicular to the direction of travel. The depression shall have a smooth flat surface with a ¾ inch depth at beginning (maximum allowable depth is 1 inch). The groove shall be placed for a stretch of 3 feet with a 2 foot stripe centered 80 feet between every other white skip lines on the roadway.

As shown in FIG. 2, a retroreflective element 28 can be provided on the bottom surface 22 of groove 12 near distal end 26 to assist motorists in viewing a line marking in dark or inclement weather. Because of the slope of groove 12, rain and snow melt will flow down bottom surface 22 of groove 12 to accumulate at the proximal end 24. This will leave the portion of bottom surface 22 of distal end 26 generally free of accumulated water and dirt, enhancing visibility of retroreflective element 28.

Moreover, the angle of the slope of bottom surface 22 of groove 12 assists in directing the reflected light from retroreflective element 28 to the motorist. Because the angle of reflection is directed closer to the motorist's field of vision the reflected light from retroreflective elements 28 will appear brighter.

The retroreflective elements can take many forms. The elements can be retroreflective beads applied to a binder, a homogeneous thermoplastic mixture containing retroreflective beads, a preform, or a reflector. In the case of retroreflective beads, the binder can be either an acrylic or a thermoplastic binder.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the endpoints.

What is claimed is:

1. A method of marking a roadway comprising the steps of:
a) applying a recessed longitudinal groove in a roadway parallel to the direction of traffic, said groove having an inclined bottom surface gradually tapering upward in the direction of traffic on the roadway, said groove being deeper on the proximal end than on the distal end; and
b) providing at least one retroreflective element in said groove.

2. The method of claim 1, wherein said at least one reflective element is provided on an upper portion of said groove nearest the distal end of said groove.

3. The method of claim 1, wherein said retroreflective element is at least one of a reflector, a preformed reflective member, and a layer of retroreflective beads provided on a binder.

4. The method of claim 3, wherein said binder is one of an acrylic and a thermoplastic binder.

5. The method of claim 1, wherein said groove is interspersed on said roadway intermediate a pair of line markings applied to the surface of said roadway.

6. A roadway marking comprising:
a) a recessed longitudinal groove provided in a roadway parallel to the direction of traffic, said groove having an inclined bottom surface gradually tapering upward in the direction of traffic on the roadway; and
b) at least one retroreflective element provided in said groove.

7. The roadway marking of claim 6, wherein said at least one reflective element is provided on an upper portion of said groove nearest the distal end of said groove

8. The roadway marking of claim 6, wherein said retroreflective element is at least one of a reflector, a preformed reflective member, and a layer of retroreflective beads provided on a binder.

9. The roadway marking of claim 8, wherein said binder is one of an acrylic and a thermoplastic binder.

10. The roadway marking of claim 6, wherein said groove is interspersed on said roadway intermediate a pair of line markings applied to the surface of said roadway
